(19) United States
(12) Patent Application Publication
(10) Pub. No.: US 2006/0058998 A1
(43) Pub. Date: Mar. 16, 2006

(54) Indexing apparatus and indexing method

(75) Inventors: Koichi Yamamoto, Kanagawa (JP); Takashi Masuko, Kanagawa (JP); Shinichi Tanaka, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/202,155

(22) Filed: Aug. 12, 2005

(30) Foreign Application Priority Data
Sep. 16, 2004 (JP) 2004-270448

(51) Int. Cl. G10L 15/04

(52) U.S. Cl. 704/254

(57) ABSTRACT

An indexing apparatus includes an acquiring unit that acquires an acoustic signal; a dividing unit that divides the acoustic signal into a plurality of segments; an acoustic model producing unit that produces an acoustic model for each of the segments; a reliability determining unit that determines reliability of the acoustic model; a similarity vector producing unit that produces a similarity vector having elements that are the similarities between the acoustic model for a predetermined segment and the acoustic signal of each of the other segments, based on the reliability; a clustering unit that clusters similarity vectors produced by the similarity vector producing unit; and an indexing unit that indexes the acoustic signal based on the similarity vectors clustered.

### CROSS-REFERENCE TO RELATED APPLICATIONS

This application is based upon and claims the benefit of priority from the priority Japanese Patent Application No. 2004-270448, filed on Sep. 16, 2004; the entire contents of which are incorporated herein by reference.

### BACKGROUND OF THE INVENTION

1. Field of the Invention

The present invention relates to an indexing apparatus that provides an audio signal with an index, an indexing method, and an indexing program.

2. Description of the Related Art

By a known conventional indexing method for providing an acoustic signal with an index, each acoustic signal is divided into segments, and the segments are classified, using the similarities among the segments. Such an indexing method utilizing the similarities between segments is disclosed by Yvonne Moh, Patrick Nguyen, and Jean-Claude Junqua in “TOWARDS DOMAIN INDEPENDENT SPEAKER CLUSTERING” in Proc. IEEE-ICASSP, vol. 2, pp. 85-88, 2003.

By providing an acoustic signal with an index, a large amount of stored data can be processed with efficiency. For example, speaker information that indicates to which speaker each voice signal belongs among the voice signals of a TV broadcasting program is provided as an index. By doing so, each speaker can be easily searched for among the voice signals of the TV broadcasting program.

By such a conventional indexing technique, however, there are cases where accurate similarities among segments cannot be judged due to adverse influence of noise, and accurate indexing cannot be performed. Therefore, accurate indexing cannot be performed on various types of acoustic signals. To counter this problem, the indexing accuracy is expected to be increased.

### SUMMARY OF THE INVENTION

According to one aspect of the present invention, an indexing apparatus includes an acquiring unit that acquires an acoustic signal; a dividing unit that divides the acoustic signal into a plurality of segments; an acoustic model producing unit that produces an acoustic model for each of the segments; a reliability determining unit that determines reliability of the acoustic model; a similarity vector producing unit that produces a similarity vector having elements that are the similarities between the acoustic model for a predetermined segment and the acoustic signal of each of the other segments, based on the reliability of the acoustic model; a clustering unit that clusters similarity vectors produced by the similarity vector producing unit; and an indexing unit that indexes the acoustic signal based on the similarity vectors clustered.

According to another aspect of the present invention, an indexing apparatus includes an acquiring unit that acquires an acoustic signal; a dividing unit that divides the acoustic signal into a plurality of segments; an acoustic model producing unit that produces an acoustic model for each of the segments; an acoustic type discriminating unit that discriminates an acoustic type of each of the segments; a similarity vector producing unit that produces a similarity vector based on the acoustic type; a clustering unit that clusters the similarity vectors produced by the similarity vector producing unit; and an indexing unit that provides the acoustic signal with an index based on the similarity vectors clustered.

According to still another aspect of the present invention, an indexing method includes acquiring an acoustic signal; dividing the acoustic signal into a plurality of segments; producing an acoustic model for each of the segments; determining reliability of the acoustic model; producing a similarity vector having elements that are the similarities between the acoustic model for a predetermined segment and the acoustic signal of each of the other segments, based on the reliability of the acoustic model; clustering similarity vectors produced; and indexing the acoustic signal based on the similarity vectors clustered.

According to still another aspect of the present invention, an indexing method includes acquiring an acoustic signal; dividing the acoustic signal into a plurality of segments; producing an acoustic model for each of the segments; discriminating an acoustic type of each of the segments; producing a similarity vector based on the acoustic type; clustering the similarity vectors produced; and indexing the acoustic signal with an index based on the similarity vectors clustered.

A computer program product according to still another aspect of the present invention causes a computer to perform the indexing method according to the present invention.

### BRIEF DESCRIPTION OF THE DRAWINGS

FIG. 1 is a block diagram showing the functional structure of an indexing apparatus 10 that performs indexing on acoustic signals by an indexing method of a first embodiment of the present invention;

FIG. 2 shows the operation of the dividing unit 104 of the indexing apparatus;

FIG. 3 shows the operation of the similarity vector producing unit 110 of the indexing apparatus;

FIG. 4 shows examples of similarity vectors produced by the similarity vector producing unit 110;

FIG. 5 shows the operation of the similarity vector producing unit 110;

FIG. 6 shows the hardware structure of the indexing apparatus according to the first embodiment;

FIG. 7 is a block diagram showing the functional structure of an indexing apparatus according to a second embodiment of the present invention;

FIG. 8 is a block diagram showing the functional structure of an indexing apparatus according to a fourth embodiment of the present invention;

FIG. 9 shows a representative model in the case of clustering with GMM;

FIG. 10 shows a representative model in the case of clustering by K-means; and

FIG. 11 is a block diagram showing the functional structure of a modification of the indexing apparatus 10 according to the fourth embodiment.

### DETAILED DESCRIPTION OF THE PREFERRED EMBODIMENTS

The following is a detailed description of embodiments of indexing apparatus, indexing methods, and indexing programs according to the present invention, with reference to the accompanying drawings. It should be noted that the present invention is not limited to the following embodiments.

### First Embodiment

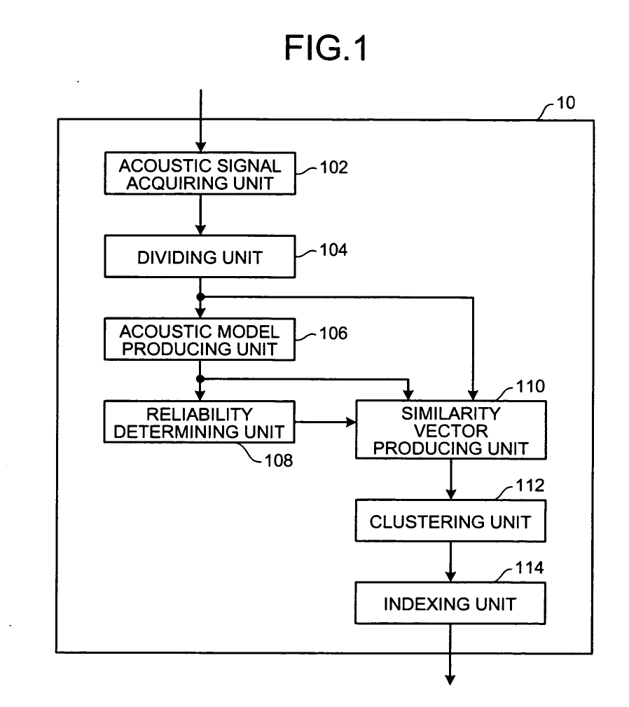

FIG. 1 is a block diagram showing the functional structure of an indexing apparatus 10 that indexes acoustic signals by an indexing system according to a first embodiment of the present invention.

The indexing apparatus 10 includes an acoustic signal acquiring unit 102, a dividing unit 104, an acoustic model producing unit 106, a reliability determining unit 108, a similarity vector producing unit 110, a clustering unit 112, and an indexing unit 114.

The acoustic signal acquiring unit 102 acquires an acoustic signal that is input from the outside via a microphone or the like. The dividing unit 104 receives the acoustic signal from the acoustic signal acquiring unit 102. The dividing unit 104 then divides the acoustic signal into segments, using the information as to power or zero-cross values, for example.

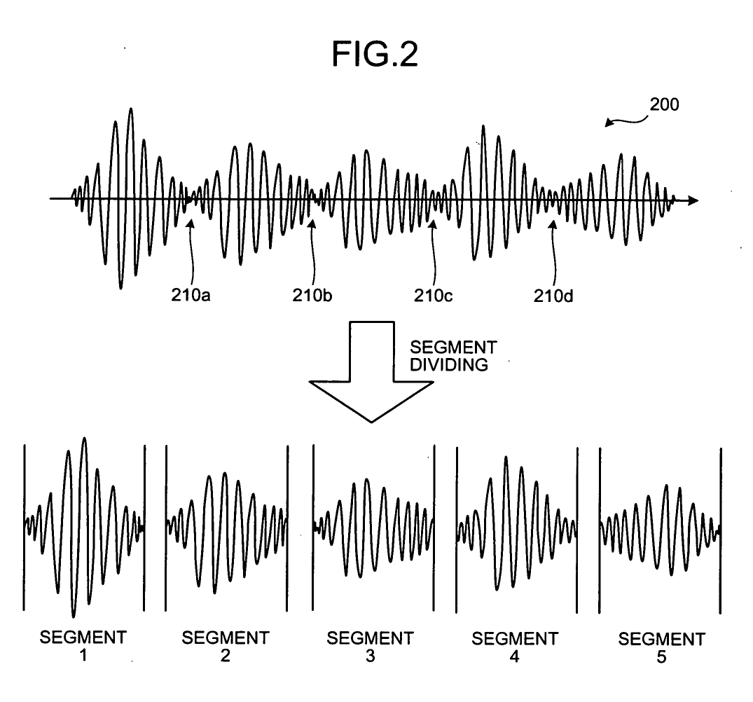

FIG. 2 shows the operation of the dividing unit 104. The dividing unit 104 divides an acoustic signal 200, shown on the upper half of FIG. 2, into several segments, with dividing points 210a to 210d being boundary points. Segment 1 to Segment 5 shown on the lower half are obtained from the above acoustic signal 200. Segment 1 to Segment 5 may overlap one another.

As another example, one utterance may be set as one segment. In this manner, the segments may be determined according to the contents of the acoustic signal.

The acoustic model producing unit 106 produces an acoustic model for each segment. In producing acoustic models, it is preferable to use HMM, Gaussian Mixture Model (GMM), VQ code book, or the like. More specifically, the acoustic model producing unit 106 extracts the feature quantity of each segment divided by the dividing unit 104. Based on the feature quantity, the acoustic model producing unit 106 produces the acoustic model representing the feature of each segment.

The feature quantity to be used in producing an acoustic model may be determined according to the objects to be classified. When speakers are to be classified, the acoustic model producing unit 106 extracts the cepstrum feature quantity such as LPC cepstrum, MFCC, or the like. When genres of music are to be classified, the acoustic model producing unit 106 extracts the feature quantity such as the pitch or zero-cross values as well as cepstrums.

By extracting the feature quantity that is suitable for the objects to be classified, desired indexing can be performed for each type of object to be classified.

The feature quantity to be extracted may be changed by users. Accordingly, the feature quantity that is suitable for the object to be classified can be extracted from each acoustic signal.

Each acoustic model to be produced by the acoustic model producing unit 106 may be of any type, as long as the acoustic type of each segment is reflected. Also, the method of producing an acoustic model is not limited to this embodiment.

The reliability determining unit 108 determines the reliability of each acoustic model produced by the acoustic model producing unit 106. The reliability determining unit 108 determines the reliability based on the length of each segment. For a longer segment, a greater value is set as the reliability.

More specifically, the segment length of each segment may be set as the reliability of the corresponding acoustic model. For example, the reliability of an acoustic model produced for a segment of 1.0 sec is set to “1”, and the reliability of an acoustic model produced for a segment of 2.0 sec is set to “2”.

The reliability determining unit 108 further judges whether each segment length is greater than a predetermined threshold value. The predetermined threshold value is preferably 1.0 sec, for example.

Here, the reliability is explained in detail. In general, where an acoustic model is to be produced, as the amount of learning data becomes larger, the reliability of the acoustic model becomes higher. When similarity vectors are produced based on an acoustic model with low reliability, the accuracy of the similarity vectors becomes undesirably low.

For example, an acoustic signal from a discussion program includes a large number of short utterances such as listening sounds. An acoustic model produced from a segment that includes a short utterance exhibits very low reliability as the model representing the acoustic type (speaker information) to which the subject segment belongs.

As described above, the reliability is a value depending on the segment length. More specifically, as the segment length is greater, the reliability is higher. The reliability determining unit 108 determines the reliability of each acoustic model, based on the segment length.

The similarity vector producing unit 110 produces similarity vectors, with the similarities between the segments obtained by the dividing unit 104 and the acoustic models produced by the acoustic model producing unit 106 being used as elements. More specifically, the similarity vector producing unit 110 produces a similarity vector, based on reliability judged by the reliability determining unit 108.

First, the principles of the operation of the similarity vector producing unit 110 are described. The similarity vector producing unit 110 produces similarity vectors, based on the similarities between the acoustic models of segments and the acoustic signals of the segments. The similarity vector Sᵢ of a segment xᵢ is expressed by the following equation:

$${S}_{i} = ( \begin{matrix}P ( {x}_{i} \vert {M}_{1} \\ P ( {x}_{i} \vert {M}_{2} \\ ⋮ \\ P ( {x}_{i} \vert {M}_{N}\end{matrix} ) \qquad ( 1 )$$

where N represents the total number of segments, xᵢ represents the acoustic signal of the i-th segment, Mᵢ represents the acoustic model of the i-th segment, and (Pxᵢ|Mⱼ) represents the similarity between the segment xᵢ and the acoustic model Mⱼ.

When an acoustic signal is divided into five segments of Segment 1 to Segment 5, the similarity vector producing unit 110 performs the following operation. First, the similarity vector producing unit 110 calculates the similarity between the acoustic model produced from Segment 1 and the acoustic signal of each segment of Segment 1 to Segment 5. Likewise, the similarity vector producing unit 110 calculates the similarity between each acoustic model of Segment 2 to Segment 5 and the acoustic signal of each of Segment 1 to Segment 5. Based on the calculated similarities, the similarity vector producing unit 110 produces a similarity vector.

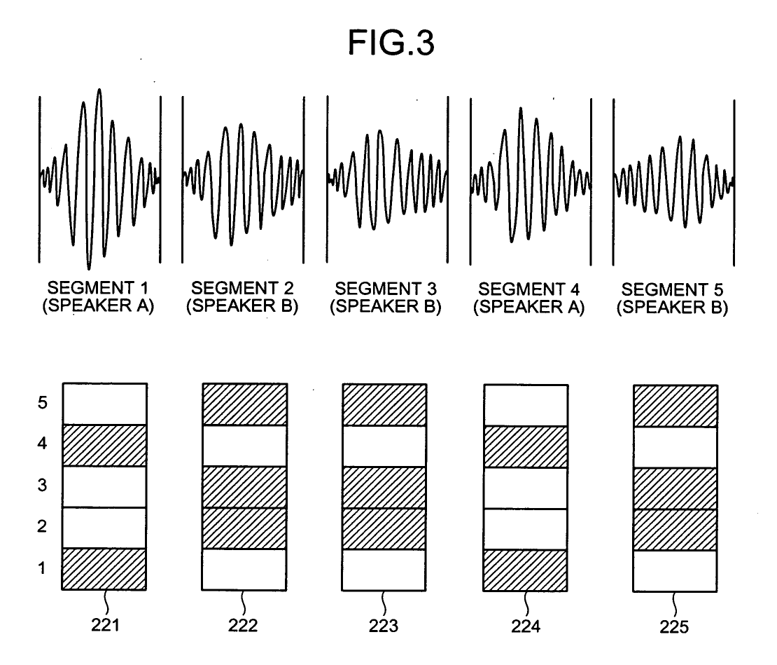

FIG. 3 shows more specific details of the operation of the similarity vector producing unit 110. Segment 1 and Segment 4 shown in FIG. 3 are the utterance segments of Speaker A. Segment 2, Segment 3, and Segment 5 are the utterance segments of Speaker B.

Since Segment 1 is one of the utterance segments of Speaker A, the similarity between Segment 1 and Segment 4, both of which are the utterance segments of Speaker A, is high. Accordingly, the similarity vector 221 of Segment 1 exhibits a high similarity with respect to Segment 1 and Segment 4. The similarity vector 224 of Segment 4 exhibits a high similarity with respect to Segment 1 and Segment 4.

Meanwhile, since Segment 2 is one of the utterance segments of Speaker B, the similarities among Segment 2, Segment 3, and Segment 5, which are the utterance segments of Speaker B, are high. Accordingly, the similarity vector 222 of Segment 2 exhibits a high similarity with respect to Segment 2, Segment 3, and Segment 5. The similarity vector 223 of Segment 3 exhibits a high similarity with respect to Segment 2, Segment 3, and Segment 5. The similarity vector 225 of Segment 5 exhibits a high similarity with respect to Segment 2, Segment 3, and Segment 5.

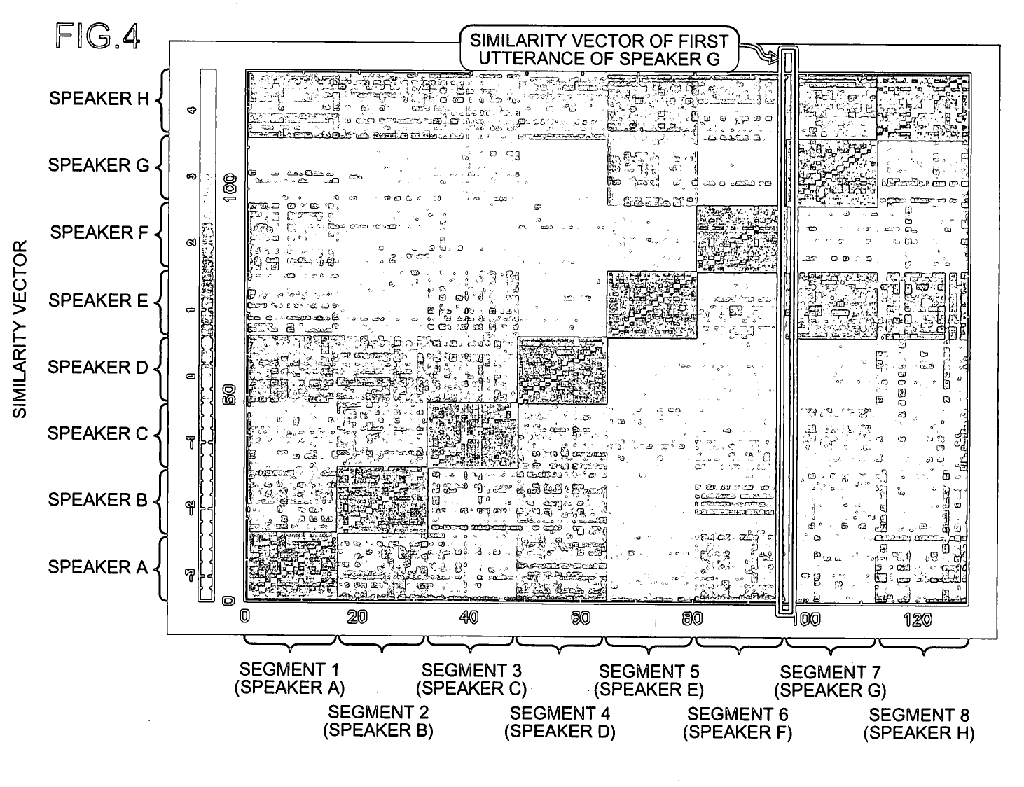

FIG. 4 shows examples of similarity vectors produced by the similarity vector producing unit 110. In FIG. 4, the abscissa axis indicates the segment numbers. The ordinate axis indicates the similarity vector of each utterance. Segment 1 is an utterance segment of Speaker A, and includes 16 utterances. Segment 2 is an utterance segment of Speaker B, and also includes 16 utterances. Likewise, the other segments include utterances of eight speakers of Speaker A to Speaker H, and each of the segments includes 16 utterances. Accordingly, an acoustic signal includes 128 utterances in total. In FIG. 4, a paler section indicates a higher similarity, and a darker section indicates a lower similarity.

Next, the features of the operation of the similarity vector producing unit 110 of this embodiment are described. The similarity vector producing unit 110 acquires the reliability of each acoustic model from the reliability determining unit 108. Based on the similarities with respect to the acoustic models with reliabilities equal to or higher than the threshold value, the similarity vector producing unit 110 produces a similarity vector. Here, the similarities with respect to acoustic models with reliabilities lower than the threshold value are not used as the elements of the similarity vector.

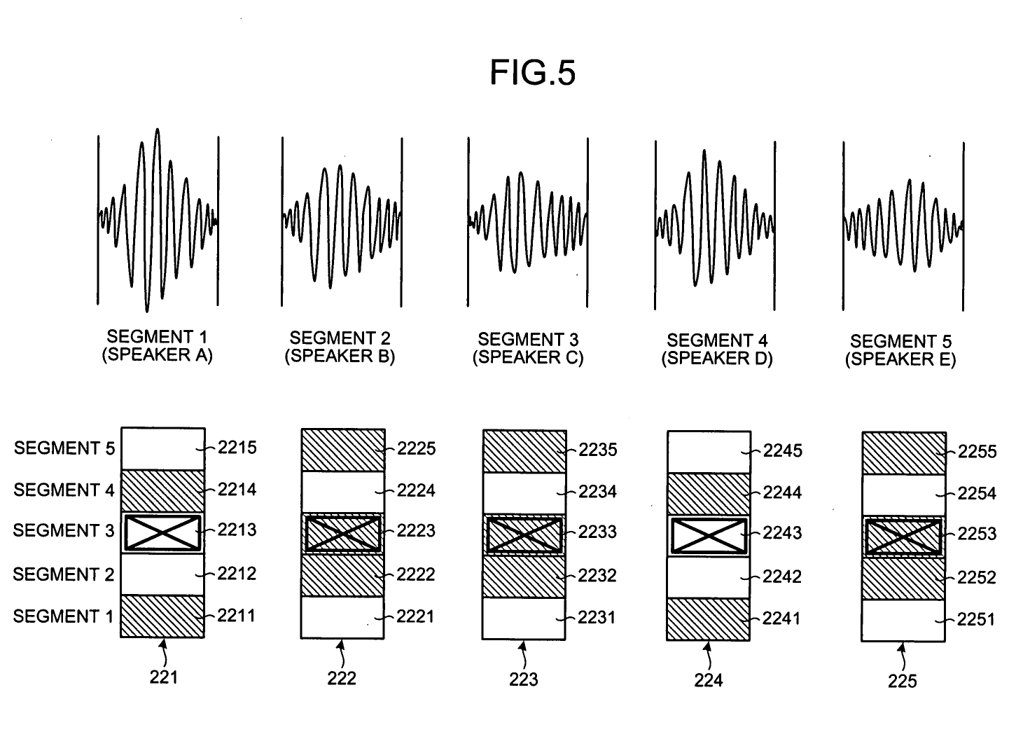

FIG. 5 shows the operation of the similarity vector producing unit 110. The reliability of the acoustic-model with respect to Segment 3 shown in FIG. 5 is equal to or lower than the threshold value. In this case, the elements 2213, 2223, 2233, 2243, and 2253 that represent the similarities between the acoustic model of Segment 3 and the acoustic signals of Segment 1 to Segment 5 are not used as the elements of the similarity vector. Accordingly, a similarity vector is produced, using the elements 2211, 2212, and 2215 of the similarity vector 221, the elements 2221, 2222, and 2225 of the similarity vector 222, the elements 2231, 2232, and 2235 of the similarity vector 223, the elements 2241, 2242, and 2245 of the similarity vector 224, and the elements 2251, 2252, and 2255 of the similarity vector 225. In this case, the similarity vector is expressed by the following equation:

$${S}_{i} = ( \begin{matrix}P ( {x}_{i} \vert {M}_{1} ) \\ P ( {x}_{i} \vert {M}_{2} ) \\ P ( {x}_{i} \vert {M}_{4} ) \\ P ( {x}_{i} \vert {M}_{5} )\end{matrix} ) \qquad ( 2 )$$

When there is an acoustic model with reliability equal to or lower than the threshold value, the similarity vector is expressed by a (N-1)-dimensional equation that is one dimension less than the similarity vector expressed by the equation (1). When the similarity vector is N-dimensional and the reliability of the acoustic model of Segment 3 is equal to or lower than the threshold value, the similarity vector is expressed by the following equation:

$${S}_{i} = ( \begin{matrix}P ( {x}_{i} \vert {M}_{1} ) \\ P ( {x}_{i} \vert {M}_{2} ) \\ P ( {x}_{i} \vert {M}_{4} ) \\ ⋮ \\ P ( {x}_{i} \vert {M}_{N}\end{matrix} ) \qquad ( 3 )$$

Likewise, when the similarity vector includes m acoustic models with reliabilities equal to or lower than the threshold value, the similarity vector is expressed by a (N-m)-dimensional equation that is m dimensions less than the similarity vector expressed by the equation (1).

Acoustic signals acquired through the acoustic signal acquiring unit 102 might include short utterances such as listening sounds or utterances with biased phonemes such as “Uh” (filler). An acoustic signal of such a segment includes only a small amount of information. Therefore, the reliability of an acoustic model produced based on the acoustic signal of such a segment is low.

In the above case where a similarity is determined by comparing an acoustic model with low reliability with the acoustic signal of another segment, the resultant similarity might be greatly different from the actual value. If the similarity is determined based on an acoustic model with such low reliability, the value of the similarity might be very biased.

When a similarity vector is produced using similarities that are greatly different from the actual similarities, a highly accurate similarity vector cannot be obtained.

In the indexing apparatus 10 of this embodiment, on the other hand, the similarity vector producing unit 10 produces a similarity model, using only acoustic models with reliabilities equal to or higher than the threshold value. Thus, a highly accurate similarity vector can be produced.

In this manner, each element of a similarity vector is processed according to the reliability of an acoustic model in this embodiment. By doing so, a highly accurate similarity vector can be produced, without adverse influence of an acoustic signal with short segments such as listening sounds or biased phonemes such as fillers.

The clustering unit 112 clusters similarity vectors produced by the similarity vector producing unit 110. By doing so, input acoustic signals can be classified. More specifically, the acoustic signals corresponding to the similarity vectors shown in FIG. 4 include the utterances by the eight speakers: Speaker A to Speaker H. Here, the clustering unit 112 performs clustering of eight clusters. Thus, speaker indexing can be performed.

In the clustering operation, it is preferable to use K-means and GMM. Here, the number of clusters may be estimated using an information reference such as Bayesian Information Criterion (BIC). In the case shown in FIG. 4, the number of clusters is estimated from the number of speakers.

The indexing unit 114 provides each acoustic signal with an index, based on the similarity vectors clustered by the clustering unit 112. More specifically, when clustering is performed on eight clusters, which correspond to the number of speakers, Speaker A to Speaker H, an index that indicates each speaker with respect to each segment is provided.

As described above, the indexing apparatus 10 of this embodiment performs clustering based on similarity vector produced not using the similarities of acoustic models with lower reliabilities. Accordingly, the accuracy of the clustering can be increased. Thus, accurate indexing can be performed.

By a conventional indexing technique, the reliability of each acoustic model is not taken into consideration when the similarity between segments is calculated. Accordingly, it has been difficult to perform accurate indexing on signals containing speaking voice, musical sounds, noise, and short utterances such as listening sounds. On the other hand, the indexing apparatus 10 of this embodiment uses similarity vectors produced based on the reliabilities of acoustic models. Thus, accurate indexing can be performed even on short utterances such as listening sounds.

Also, reliabilities are determined based on the segment length of each acoustic signal. Thus, accurate indexing can be performed, even if there are segments with difference lengths.

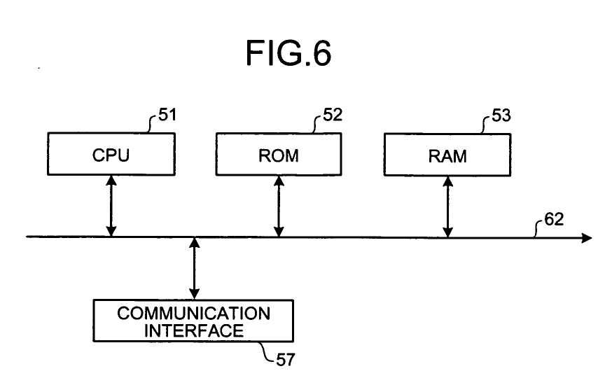

FIG. 6 shows the hardware structure of the indexing apparatus 10 of the first embodiment. The hardware structure of the indexing apparatus 10 includes a ROM 52 that stores an indexing program for performing an indexing operation in the indexing apparatus 10 or the like, a CPU 51 that controls each of the components of the indexing apparatus 10 according to the program stored in the ROM 52, a RAM 53 that stores various kinds of data necessary for controlling the indexing apparatus 10, a communication interface 57 that performs communications over a network, and a bus 62 that connects with each component.

The indexing program in the indexing apparatus 10 may be provided as recorded information on a computer-readable recording medium such as a CD-ROM, a floppy disk (FD) (registered trade mark), or a DVD in the form of a file that can be installed or executed.

In such a case, the indexing program is read out from the recording medium, and is executed in the indexing apparatus 10. Thus, the indexing program is loaded into the main memory, so that each of the components of the above described software structure is generated in the main memory.

Alternatively, the indexing program of this embodiment may be stored in a computer connected to a network such-as the Internet, and may be downloaded via the network.

Although the present invention has been described by way of the first embodiment, it is possible to make various changes and modification to the above described embodiment.

In a first modification, the reliability determining unit 108 of the first embodiment may determine reliabilities based on close similarities, instead of segments lengths.

A close similarity is the similarity between an acoustic model and an acoustic signal with respect to the same segment. The similarity vectors shown in FIG. 4 are closed at the diagonal sections. Accordingly, the diagonal sections indicate higher values than the other similarities.

In a second modification, reliabilities are determined based on close similarities, as in the first modification. Further, a similarity vector may be produced, using acoustic models that do not have reliabilities corresponding to extremely high close similarities.

There are cases where close similarities indicate extremely high values. An acoustic model indicating such an extremely high value is a result of over-training as to the subject segment. For example, when acoustic models are produced with respect to segments of “Hello” and “Uh” under the same conditions, and the close similarities between the acoustic models are compared with each other, the value of the latter acoustic model with respect to “Uh” is very large. This is because the phonemes are biased and over-training is carried out on a specific phoneme. Determining the similarity to such an over-trained acoustic model does not show any significance.

To counter this problem, the similarity vector producing 110 of the second modification sets the upper limit value for close similarities, i.e., the lower limit value for reliabilities, and produces a similarity vector using acoustic models other than those with reliabilities lower than the lower limit value. By doing so, a more accurate similarity vector can be calculated.

In a case of using acoustic models with GMM, close similarities can be expressed by likelihoods. When phonemes in a particular segment are biased or the segment length with respect to a mixed number by GMM is too short, the close likelihood exhibits an extremely large value. The similarity between such GMM and another segment does not have any significance in many cases. To counter this problem, the similarity vector producing unit 110 does not use a likelihood value as an element of a similarity vector, if the likelihood indicates an extremely large value.

In the first embodiment, the similarity vector producing unit 110 produces a similarity vector using acoustic models with reliabilities equal to or higher than the threshold value. In a third modification of the first embodiment, the similarity vector producing unit 110 performs weighting on each element of a similarity vector according to the reliability of the corresponding acoustic model.

The similarity vector producing unit 110 produces a similarity vector that is expressed by the following equation:

$${S}_{i} = ( \begin{matrix}{w}_{1} ⋆ P ( {x}_{i} \vert {M}_{1} ) \\ {w}_{2} ⋆ P ( {x}_{i} \vert {M}_{2} ) \\ ⋮ \\ {w}_{N} ⋆ P ( {x}_{i} \vert {M}_{N} )\end{matrix} ) \qquad ( 4 )$$

where wᵢ indicates the weight that is given to the similarity to the i-th acoustic model. The weight wᵢ is determined according to the reliability of the corresponding acoustic model.

For example, a threshold value is set for reliabilities, and the weighting value is set to “1” when a reliability value is equal to or greater than the threshold value. When a reliability value is equal to or smaller than the threshold value, the weighting value is set to “0”. In this manner, the weighting value is switched between the two values “0” and “1”. Thus, the preset value according to a reliability value is determined to be the weighting value.

Although the weighting value is switched between the two values in the above described third modification, it is possible for the weighting value to take three or more values. For example, divided segment lengths may be used as weighting values. More specifically, the weighting value for a segment of 2.0 sec is set to “2.0”, the weighting value for a segment of 2.1 sec is set to “2.1”, and the weighting value for a segment of 4.0 sec is set to “4.0”. In this manner, a weighting value that is switched among the number of values corresponding to the minimum unit of segment lengths can be provided. Therefore, the number of values that can be given to a weighting value is not limited to the example of the third modification.

Although each element is multiplied by the weighting value in Equation (3), the weighting method is not limited to that either. Instead, the weighing value may be added to each element.

As described above, elements with higher reliabilities have greater influence on a similarity vector in the third modification. Accordingly, a highly accurate similarity vector can be produced. Using a similarity vector produced by the similarity vector producing unit 110 of the third modification, the accuracy of clustering can be increased.

In a fourth modification, the similarity vector producing unit 110 replaces the elements of a similarity vector with a constant value, according to the reliability of the corresponding acoustic vector.

More specifically, the similarity vector producing unit 110 replaces the similarities to acoustic models with reliabilities lower than a predetermined threshold value with a constant value. Equation (5) shows a similarity vector in the case of replacing the elements with “0”. In the similarity vector shown in the equation below, the reliability of the acoustic model of Segment 3 is lower than the threshold value.

$${S}_{i} = ( \begin{matrix}P ( {x}_{i} \vert {M}_{1} ) \\ P ( {x}_{i} \vert {M}_{2} ) \\ 0 \\ P ( {x}_{i} \vert {M}_{4} ) \\ ⋮ \\ P ( {x}_{i} \vert {M}_{N} )\end{matrix} ) \qquad ( 5 )$$

As described above, the elements for acoustic models with lower reliabilities are replaced with “0” in the fourth embodiment. By doing so, the adverse influence of the acoustic models with lower reliabilities on the similarity vector can be reduced. Thus, a more accurate similarity vector can be produced.

In yet another modification, the similarities to acoustic models with reliabilities equal to or higher than a predetermined threshold value may be replaced with a constant value. More specifically, the reliabilities equal to or higher than the threshold value are replaced with “1”. By doing so, extremely high reliability values can be replaced with “1”. Such extremely high reliability values are often inaccurate. Therefore, extremely high reliability values are replaced with “1”, so as to reduce the adverse influence of acoustic vectors with extremely high reliabilities on the similarity vector. Thus, a highly accurate similarity vector can be produced.

In a fifth modification, when a certain element of a similarity vector is of an extreme value, the certain element is not used. More specifically, when an element of a similarity vector is of an extremely large value, the clustering unit 112 does not use the element of the similarity vector in the clustering operation. Alternatively, when an element of a similarity vector is of an extremely small value, the clustering unit 112 does not use the element in the clustering operation.

In yet another modification, when an element of a similarity vector is of an extremely small value or an extremely large value, the clustering unit 112 does not use the element of the similarity vector in the clustering operation.

To spot an extremely large element or an extremely small element in a similarity vector, a threshold value for similarity vectors is set. For example, any value that is equal to or smaller than a predetermined threshold value is decided to be an extremely large value, and the corresponding element of the similarity vector is not to be used in a clustering operation.

Also, each value may be decided whether to be an extreme value, based on the dispersion of the elements of similarity vectors. As long as all extreme values are to be spotted, the method of doing so is not limited to this example.

In the first embodiment, the dividing unit 104 determines the width of each segment, using the information such as power and zero-cross values. Instead, the dividing unit 104 as a sixth modification may divide an acoustic signal into predetermined constant widths, not using the information. More specifically, an acoustic signal may be divided into segments of 1.0 sec. The width of each segment is preferably 1.0 sec to 2.0 sec.

In such a case, all divided segments have the same lengths. Accordingly, the reliabilities determined by the segment lengths exhibit the same values, and do not have any significance. Therefore, the reliability determining unit 108 should preferably determine reliability values, based on information other than the segment lengths, such as close similarities.

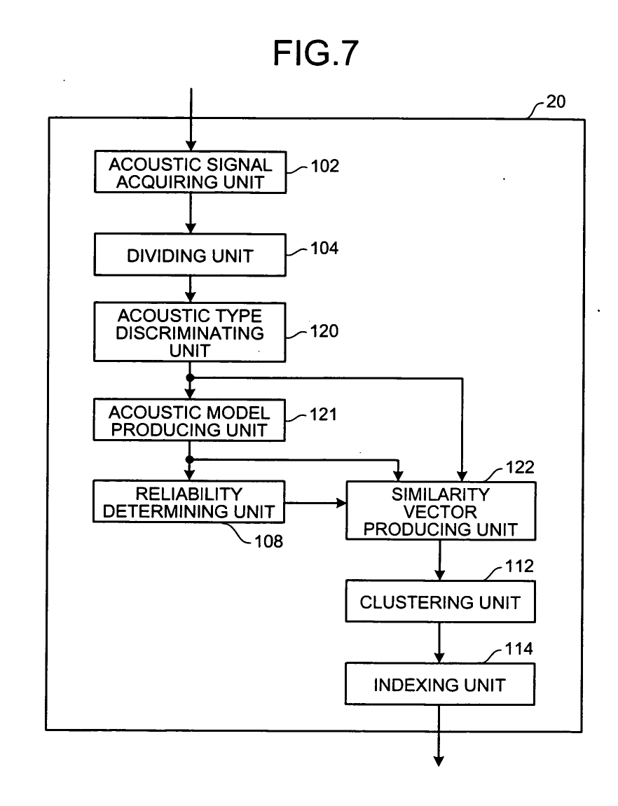

FIG. 7 is a block diagram showing the functional structure of an indexing apparatus according to a second embodiment of the present invention. The indexing apparatus 20 according to the second embodiment differs from the indexing apparatus 10 according to the first embodiment in that it includes an acoustic type discriminating unit 120.

The acoustic type discriminating unit 120 discriminates the type of the acoustic signal of each segment divided by the dividing unit 104. When indexing is to be performed on the speakers of input acoustic signals, the non-voice signals representing music and noise contained in the acoustic signals are irrelevant signals. Therefore, the acoustic type discriminating unit 120 discriminates between voice signals and non-voice signals.

More specifically, each input acoustic-signal is divided into blocks of 1.0 sec to 2.0 sec, and block cepstrum flux (BCF) is extracted from each block. If the extracted BCF is greater than a predetermined threshold value, the corresponding block is discriminated to be of voice. If the extracted BCF is smaller than the predetermined threshold value, the corresponding block is judged to be of music. Here, BCF is a value that is obtained by averaging cepstrum flux of each frame by the block.

To do so, the method that is disclosed in the following reference may be used: “Visual and Audio Segmentation for Video Streams”, Muramoto, T. and Sugiyama, M., Multimedia and Expo, 2000. ICME 2000. 2000 IEEE International Conference on Volume 3, 30 July-2 Aug. 2000, pages; 1547-1550 vol. 3.

The acoustic model producing unit 121 produces acoustic models for segments that are discriminated to be the kinds to be indexed by the acoustic type discriminating unit 120. For example, when indexing is to be performed on speakers, acoustic models are produced only for segments of voice among acoustic signals.

To produce a similarity vector, the similarity vector producing unit 122 uses the acoustic signals and acoustic models of the segments of the kinds to be indexed. In other words, a similarity vector whose elements are the similarities to the acoustic models of the segments of the kinds to be indexed is produced.

The other aspects of the structure and operation of the indexing apparatus 20 according to the second embodiment are the same as those of the structure and operation of the indexing apparatus 10 according to the first embodiment.

By a conventional technique, acoustic types are not discriminated, and therefore, it is difficult to perform accurate indexing on acoustic signals containing voice, music, and noise. By the above described method, on the other hand, the acoustic types of divided segments are discriminated, and the segments of the kinds to be indexed are processed. In this manner, irrelevant sound signals that are not to be indexed, such as noise, can be eliminated. Accordingly, accurate indexing can be performed on desired acoustic signals.

Also, by limiting the segments to be indexed, unnecessary procedures can be omitted. Thus, higher efficiency can be achieved.

In this embodiment, voice signals and non-voice signals are discriminated. However, it is also possible to make a distinction between male voice and female voice or to discriminate the language that is being used.

An indexing apparatus according to a third embodiment of the present invention is described. The functional structure of the indexing apparatus according to the third embodiment is the same as that of the indexing apparatus 20 according to the second embodiment. However, the indexing apparatus according to the third embodiment differs from the indexing apparatus according to any of the foregoing embodiments in that “likelihood of voice” is used as the reliability of each acoustic model.

The acoustic type discriminating unit 120 discriminates the likelihood of voice with respect to each segment divided by the dividing unit 104. To set the likelihood of voice, the likelihood of a predetermined voice model may be calculated.

Alternatively, the acoustic type discriminating unit 120 sets “1” as the value of the likelihood of voice, when a segment is discriminated to be of voice. When a segment is discriminated to be of non-voice, the acoustic type discriminating unit 120 sets “0” as the value of the likelihood of voice. To discriminates the likelihood of voice with respect to each segment, the value of the likelihood may be discriminates whether to be “1” or “0”.

The reliability determining unit 108 determines reliability, based on the value of the likelihood of voice discriminated by the acoustic type discriminating unit 120. In other words, the value of the likelihood of voice is used as the reliability value. When the likelihood of voice is indicated by the two values, the reliability is also indicated by the two values. Further, the reliability determining unit 108 uses “1” as the threshold value.

The similarity vector producing unit 110 produces each acoustic model, using the likelihood of voice, which is discriminated by the acoustic type discriminating unit 120, as the reliability. More specifically, the similarity vector producing unit 110 producing a similarity vector for the segments that indicate the threshold value “1”.

As described above, the indexing apparatus according to the third embodiment produces a similarity vector based on the likelihood of voice. Accordingly, adverse influence of noise, which is not to be indexed, can be restricted. Thus, a highly accurate similarity vector can be produced.

The other aspects of the structure and operation of the indexing apparatus according to the third embodiment are the same as those of the structure and operation of the indexing apparatus 10 according to the first embodiment.

In another modification, the likelihood of voice of each segment may be used as the reliability of the corresponding acoustic model, and the reliability may be added as a weight to each element of the similarity vector.

For example, when the likelihood of voice of segments (1, 2, 3, . . . , N) are set to (1, 0, 2, . . . , 1.5), the similarity vector Sᵢ of a segment xᵢ is expressed by the following equation:

$${S}_{i} = ( \begin{matrix}1 ⋆ P ( {x}_{i} \vert {M}_{1} ) \\ 0 ⋆ P ( {x}_{i} \vert {M}_{2} ) \\ 2 ⋆ P ( {x}_{i} \vert {M}_{3} ) \\ ⋮ \\ 1.5 ⋆ P ( {x}_{i} \vert {M}_{N}\end{matrix} ) \qquad ( 6 )$$

In this equation, N represents the total number of segments, xᵢ represents the acoustic signal of the i-th segment, Mᵢ represents the acoustic model of the i-th segment, and P(xᵢ|Mⱼ) represents the similarity between the segment xᵢ and the acoustic model Mⱼ.

In this manner, weighting according to the likelihood of voice is performed on a similarity vector. By doing so, adverse influence of acoustic models with low likelihoods of voice can be restricted. Acoustic models with low likelihoods of voice include acoustic models that are produced from acoustic segments in which non-voice signals such as musical signals and noise are overlapped.

In this embodiment, a similarity vector is produced based on likelihoods of voice. However, it is also possible to produce a similarity vector based on likelihoods of music, when indexing is to be performed on music. By doing so, accurate music indexing can be performed.

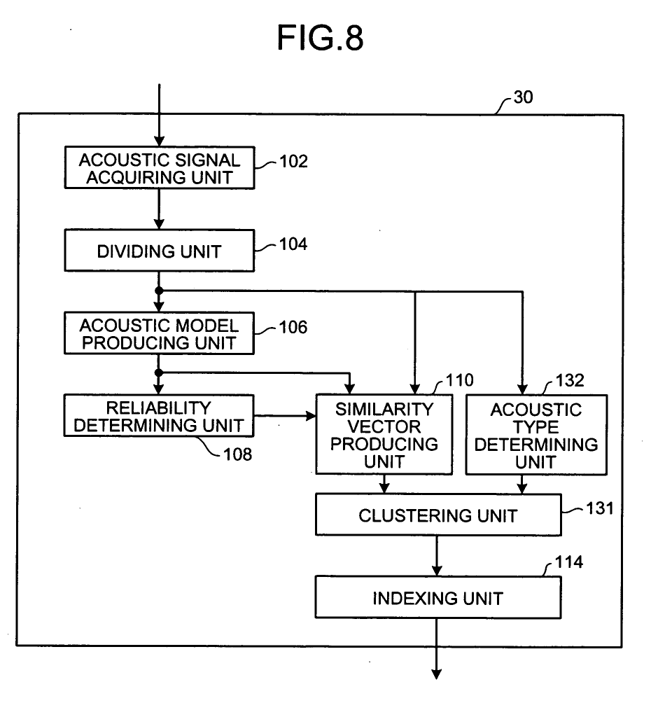

Next, an indexing apparatus according to a fourth embodiment of the present invention is described. FIG. 8 is a block diagram showing the functional structure of the indexing apparatus 30 according to the fourth embodiment. The function of each component is the same as the function of the equivalent component (denoted by the same reference numeral) of any of the indexing apparatuss of the first and second embodiments.

In the indexing apparatus 30 according to the fourth embodiment, the acoustic type discriminating unit 132 discriminates between clean voice signals and noise overlapped voice signals. The clustering unit 131 produces a representative model of clustering, using a similarity vector produced based on segments that are discriminated to be of clean voice signals by the acoustic type discriminating unit 132. In this aspect, the indexing apparatus 30 according to the fourth embodiment differs from the indexing apparatus 30 according to any of the foregoing embodiments.

In this embodiment, the acoustic type discriminating unit 132 classifies acoustic signals into clean voice signals and noise overlapped voice signals, so as to perform speaker indexing on the acoustic signals.

Specifically, each input acoustic signal is divided into blocks of 1 sec, and 26 different types of feature values are extracted from each block. Here, the feature values include the average and dispersion of short-time zero-cross values, the average and dispersion of short-time power, and the strength of the harmonic structure. Based on those feature values, clean voice signals and noise overlapped voice signals are discriminated.

More Specifically, the technique that is disclosed by Y. Li and C. Dorai in “SVM-based Audio Classification for Instructional Video Analysis”, ICASSP 2004, V 897-900, 2004, may be used, for example.

The clustering unit 132 produces a representative model of clustering, using a similarity vector of a segment that is discriminated to be of a clean voice signal by the acoustic type discriminating unit 131. The clustering unit 132 then clusters all the segments that contain noise overlapped voice signals, using the representative model.

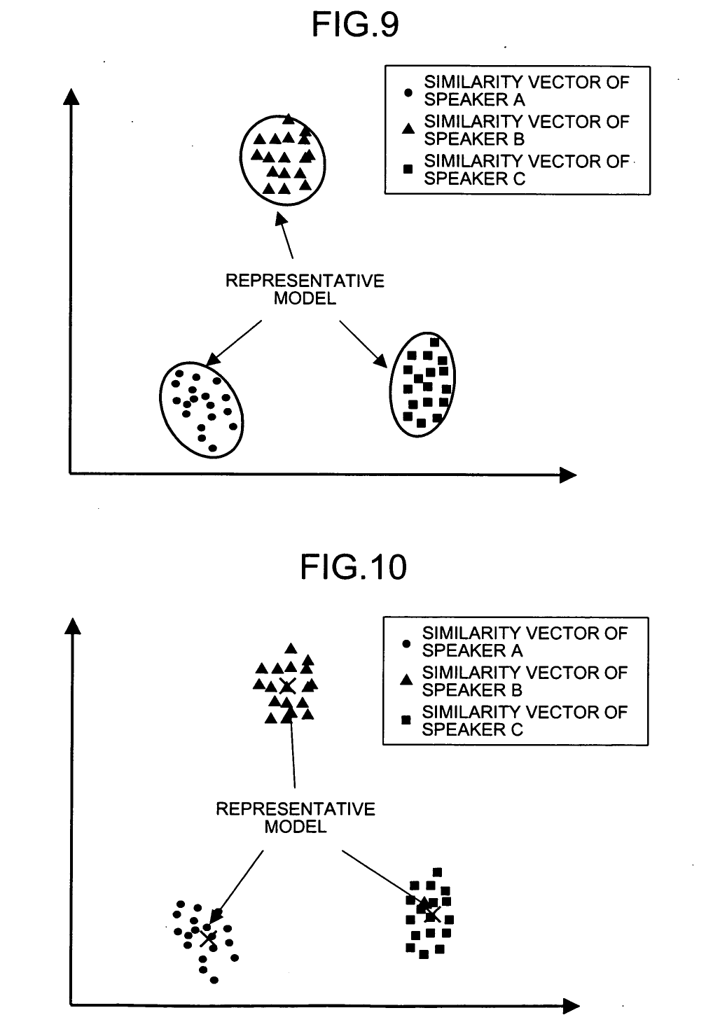

FIG. 9 shows the clustering operation, showing the representative model in the case of performing clustering with GMM. Normally, a similarity vector has the same number of dimensions as the number of utterance segments. In FIGS. 9 and 10, however, two-dimensional feature vectors are shown, for ease of explanation. The x axis indicates the first element of an utterance similarity vector, and the y axis indicates the second element of an utterance similarity vector.

In the case of clustering with GMM, the representative model shows a mixed Gaussian distribution that is learned from a sample set.

In this manner, the clustering unit 132 of this embodiment produces a representative model, using the similarity vector of segments that are discriminated to be of clean voice signals. Thus, a highly accurate representative model can be produced.

The other aspects of the structure and operation of the indexing apparatus 30 according to the fourth embodiment are the same as those of the structure and operation of the indexing apparatus 10 according to the first embodiment.

Although clustering is performed with GMM in this embodiment, it may be performed by K-means. In the case of clustering with GMM, the Gaussian distribution of each cluster is obtained.

FIG. 10 shows the representative model in the case of clustering by K-means. In such a case, the representative model is the representative point (the gravity center of each cluster) learned from a sample set in the case of clustering by K-means. As in the case of clustering with GMM, the representative model is produced based on only clean voice signals. Thus, a highly accurate representative model can be obtained.

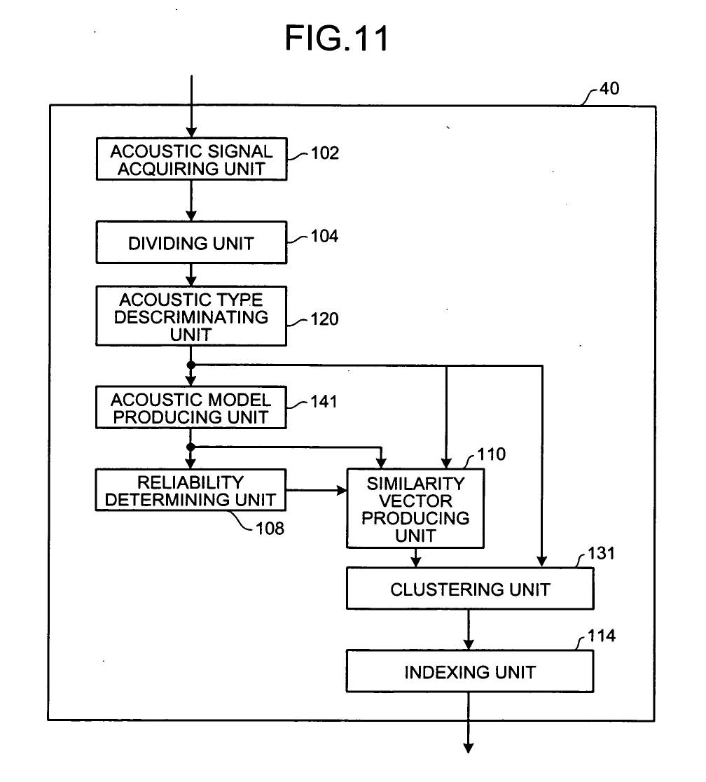

FIG. 11 is a block diagram showing the functional structure of a modification of the indexing apparatus according to the fourth embodiment. In the indexing apparatus 40 of this modification, the acoustic model producing unit 106 produces acoustic models with respect to the segments of the acoustic kinds to be clustered, based on the result of the determination by the acoustic type discriminating unit 120 as with the acoustic model producing unit 106 according to the second embodiment.

In this manner, clustering is performed based on only the segments of the acoustic kinds to be clustered. Thus, the accuracy of the clustering operation can be further increased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An indexing apparatus comprising:
an acquiring unit that acquires an acoustic signal;
a dividing unit that divides the acoustic signal into a plurality of segments;
an acoustic model producing unit that produces an acoustic model for each of the segments;
a reliability determining unit that determines reliability of the acoustic model;
a similarity vector producing unit that produces a similarity vector having elements that are the similarities between the acoustic model for a predetermined segment and the acoustic signal of each of the other segments, based on the reliability of the acoustic model;
a clustering unit that clusters similarity vectors produced by the similarity vector producing unit; and
an indexing unit that indexes the acoustic signal based on the similarity vectors clustered.

2. The indexing apparatus according to claim 1, wherein the similarity vector producing unit produces the similarity vector having elements that are similarities between the acoustic model for an segment with reliabilities not less than a predetermined threshold value and the acoustic model of each of the other segments.

3. The indexing apparatus according to claim 1, wherein the similarity vector producing unit performs weighting on the similarity to each acoustic model according to the reliabilities of acoustic models produced by the acoustic model producing unit, and produces the similarity vector with the weighted similarities as elements.

4. The indexing apparatus according to claim 1, wherein the similarity vector producing unit determines the similarities to acoustic models to be predetermined values for the reliabilities of the acoustic models produced by the acoustic model producing unit, and produces the similarity vector with the similarities as elements.

5. The indexing apparatus according to claim 4, wherein the similarity vector producing unit determines the predetermined values to be the similarities to the acoustic models, when the reliability of the acoustic model produced by the acoustic model producing unit is not less than a predetermined threshold value, and produces the similarity vector with the similarities as elements.

6. The indexing apparatus according to claim 4, wherein the similarity vector producing unit determines predetermined values as the similarities to the acoustic models, and produces the similarity vector with the similarities as elements, when the reliabilities of the acoustic models produced by the acoustic model producing unit are not more than a predetermined threshold value.

7. The indexing apparatus according to claim 1, wherein the reliability determining unit determines the reliability, based on the segment length of each acoustic model produced by the acoustic model producing unit.

8. The indexing apparatus according to claim 5, wherein the reliability determining unit determines a high value to be the reliability, when the segment length of each acoustic model produced by the acoustic model producing unit is longer.

9. The indexing apparatus according to claim 1, wherein the reliability determining unit determines the reliability, based on the similarity between each acoustic model produced by the acoustic model producing unit and the acoustic signal of the subject segment.

10. The indexing apparatus according to claim 7, wherein the reliability determining unit determines a low value to be the reliability, when the degree of similarity between the acoustic model produced for a predetermined segment by the acoustic model producing unit and the acoustic signal of the predetermined segment is high.

11. The indexing apparatus according to claim 1, further comprising
an acoustic type discriminating unit that discriminates an acoustic type of the acoustic signal of each segment,
wherein the similarity vector producing unit produces the similarity vector based on the acoustic type.

12. The indexing apparatus according to claim 11, wherein the similarity vector producing unit produces the similarity vector based on the acoustic signal of each segment that is discriminated to be of a predetermined acoustic type by the acoustic type discriminating unit.

13. The indexing apparatus according to claim 11, wherein the reliability determining unit determines the reliability based on the acoustic type discriminated by the acoustic type discriminating unit.

14. The indexing apparatus according to claim 13, wherein
the acoustic type discriminating unit discriminates the acoustic type of the acoustic signal, and calculates a likelihood of the acoustic type discriminated, and
the reliability determining unit determines the reliability based on the likelihood of the acoustic type discriminated by the acoustic type discriminating unit.

15. The indexing apparatus according to claim 14, wherein the reliability determining unit determines a higher value to be the reliability, when the likelihood of the acoustic type discriminated by the acoustic type discriminating unit is higher.

16. The indexing apparatus according to claim 1, further comprising
an acoustic type discriminating unit that discriminates the acoustic type of the acoustic signal of each segment,
wherein the clustering unit calculates a representative point of each cluster based on the acoustic type discriminated by the acoustic type discriminating unit, and clusters a plurality of similarity vectors based on the representative point.

17. An indexing apparatus comprising:
an acquiring unit that acquires an acoustic signal;
a dividing unit that divides the acoustic signal into a plurality of segments;
an acoustic model producing unit that produces an acoustic model for each of the segments;
an acoustic type discriminating unit that discriminates an acoustic type of each of the segments;
a similarity vector producing unit that produces a similarity vector based on the acoustic type;
a clustering unit that clusters the similarity vectors produced by the similarity vector producing unit; and
an indexing unit that provides the acoustic signal with an index-based on the similarity vectors clustered.

18. An indexing method comprising:
acquiring an acoustic signal;
dividing the acoustic signal into a plurality of segments;
producing an acoustic model for each of the segments;
determining reliability of the acoustic model;
producing a similarity vector having elements that are the similarities between the acoustic model for a predetermined segment and the acoustic signal of each of the other segments, based on the reliability of the acoustic model;
clustering similarity vectors produced; and
indexing the acoustic signal based on the similarity vectors clustered.

19. An indexing method comprising:
acquiring an acoustic signal;
dividing the acoustic signal into a plurality of segments;
producing an acoustic model for each of the segments;
discriminating an acoustic type of each of the segments;
producing a similarity vector based on the acoustic type;
clustering the similarity vectors produced; and
indexing the acoustic signal with an index based on the similarity vectors clustered.

20. A computer program product having a computer readable medium including programmed instructions, wherein the instructions, when executed by a computer, cause the computer to perform:
acquiring an acoustic signal;
dividing the acoustic signal into a plurality of segments;
producing an acoustic model for each of the segments;
determining reliability of the acoustic model;
producing a similarity vector having elements that are the similarities between the acoustic model for a predetermined segment and the acoustic signal of each of the other segments, based on the reliability of the acoustic model;
clustering similarity vectors produced; and
indexing the acoustic signal based on the similarity vectors clustered.

21. A computer program product having a computer readable medium including programmed instructions, wherein the instructions, when executed by a computer, cause the computer to perform:
acquiring an acoustic signal;
dividing the acoustic signal into a plurality of segments;
producing an acoustic model for each of the segments;
discriminating an acoustic type of each of the segments;
producing a similarity vector based on the acoustic type;
clustering the similarity vectors produced; and
indexing the acoustic signal with an index based on the similarity vectors clustered.
